(19) United States
(12) Patent Application Publication
(10) Pub. No.: US 2009/0212474 A1
(43) Pub. Date: Aug. 27, 2009

(54) Energy Absorption Apparatus for Fall Protection Systems

(76) Inventor: Eric Reeves, Charlotte, NC (US)

Correspondence Address: Clements Bernard PLLC, 1901 Roxborough Road, Suite 300, Charlotte, NC, 28211, US

(21) Appl. No.: 12/390,886

(22) Filed: Feb. 23, 2009

Related U.S. Application Data
(60) Provisional application No. 61/031,141, filed on Feb. 25, 2008.

(51) Int. Cl. F16F 9/00

(52) U.S. Cl. 267/70

(57) ABSTRACT

An energy absorption device is disclosed for use both as an in-line and horizontal life line shock or energy absorbers for fall arrest systems. The energy absorption device generally includes an elongate housing sleeve constructed from two mating halves, said housing sleeve having disposed therein at least one biasing element, a plurality of reinforcing plates, a fastener for securing the mating halves of the housing sleeve together, and a honeycomb core. The honeycomb core is pre-crushed in an axial direction such that peak load forces caused by an initial fall are eliminated and the core is crushed at a substantially uniform level. Further, a pretension indicator may be provided for assisting a user in obtaining a predetermined tension on the device.

### CROSS REFERENCE TO RELATED APPLICATION

The present non-provisional patent application claims the benefit of priority of U.S. Provisional Patent Application No. 61/031,141 (Eric W. REEVES), filed on Feb. 25, 2008, and entitled “ENERGY ABSORPTION APPARATUS FOR FALL PROTECTIONS SYSTEMS,” the contents of which are incorporated in full by reference herein.

### BACKGROUND OF THE INVENTION

1. Field of the Invention

The present invention relates generally to safety devices and methods for fall protection, and more specifically, to safety devices, in an exemplary embodiment, including energy absorption devices operable for assisting in the arresting of downward movement of a person or object after a fall.

2. Technical Background

In the construction industry, it is often necessary to provide fall protection for workers or objects suspended at heights. More specifically, fall protection and safety equipment are utilized in situations which require an individual to be suspended from an elevated position for a variety of reasons, such as for work at a location below that point. Conventionally, fall protection equipment used to meet these needs include harnesses, safety hoists, life-lines and the like. One particular type of such fall protection equipment also includes energy or shock absorption devices. Such absorption devices can be utilized in line with the individual's support cable or in conjunction with horizontal life lines. The purpose of such absorption devices is to control the line tension created in horizontal life lines or vertical support lines in personnel fall arrest.

For example, horizontal life lines are particularly useful in certain applications for fall arrest because they do not require a rigid structural support over the work area, but rather can be supported by structure at each end of the work area, such as vertical I-beams at each end of an open flooring or canyon walls on each end of a bridge. The absorption device performs four main functions within the horizontal lifeline system. First, it adds hysteresis to the system; second, it adds energy capacity to the system; third, it elongates the line to decrease low sag angle load amplifications and, fourth, it can be used to “tune” a horizontal lifeline to cause the line to absorb energy at a higher rate, thus decreasing both, input energy and total fall distance. Perhaps the most important feature about the design of a horizontal lifeline absorption device is that it must elongate at a high enough force such that it does not allow the falling weight to accelerate and gain input energy any longer than necessary in the fall cycle. In other words, it must provide sufficient initial line tension to reverse the force vector of the falling weight by causing the upward force due to line tension to be equal to the falling weight. If one does not allow unnecessary energy to enter into the system at the beginning of a fall cycle, it will not be necessary to take the energy out at the end. For this reason absorption devices are designed to work with specific types of cable as compatible components and no substitutions can be made.

There are a number of devices that are designed to be shock or energy absorbers of the type described above. Such devices are designed to absorb energy while elongated during a fall arrest. A problem with certain of these devices is that they are large, cumbersome, and due to their design, are prone to malfunction by jamming, for instance. Moreover, they do not absorb sufficient energy at the beginning of the fall cycle to significantly reduce final line tension. In addition, some conventional devices do not permit the installer of the fall arrest system to pretension or tune the cable to operate in the correct force versus elongation range. Consequently, the distance a person falls during a fall arrest can be greatly increased. Thus, there remains a need for an absorption device for use with in-line or horizontal life lines which not only absorbs significant amounts of energy but also permits pre-tensioning of the fall arrest system to reduce the energy allowed to input into the system at the beginning of the fall cycle.

The importance of the need to start the energy absorption as early as possible in the fall cycle can be understood by reflecting on the fact that the amount of kinetic energy gained by a falling body continuously increases until the body in motion begins to decelerate. Therefore, in order to minimize the amount of energy needed to stop the fall of a person, for example, it is imperative that a significant decelerating force be applied as soon as the fall begins. Accordingly, in systems where the fall of a person is to be decelerated by means of a horizontal lifeline, it is important to take into consideration the elastic and energy retention properties of the cable being used at the horizontal lifeline. Most cables used as horizontal lifelines exhibit highly elastic deformation when resisting the load imposed by a falling person. This elastic deformation is detrimental to the safe deceleration of the falling individual since the elastic deformation simply stores the energy of the fall, and then returns the energy in the form of rebound energy. This rebound can create forces as high as 90% of the initial fall, greatly increasing the chance of injury to the falling worker.

The force needed to stretch an elastic element—such as an elastic horizontal lifeline is proportional to the spring constant of the lifeline times the amount of distance of stretch already imposed on the elastic element. Therefore, to quickly remove fall energy by means of the horizontal lifeline, it is important to pre-load the horizontal lifeline such that additional stretching of the horizontal lifeline will be carried out at a much higher energy level than required if the horizontal lifeline had not been pre-loaded. This means that a greater amount of energy is absorbed for a given amount of elastic deformation and loading in the horizontal lifeline. The rapid removal of energy avoids long elastic deformation which in turn reduces the total fall distance and subsequent clearances required.

Accordingly, it would be desirable to have an improved energy absorption device which overcomes the noted shortcomings of conventional devices. In one such solution, it would be desirable to provide an energy absorption device which reduces the manufacturing costs and the complexity of assembly. In other solutions, it would be desirable to provide an energy absorption device which includes a biasing element and a honeycomb core disposed in a sleeve like housing and being operable for dissipating the energy associated with a fall without significant rebound. In still other solutions, it would be desirable to provide an energy absorption device which includes a pre-tensioning indicator, a biasing element and a honeycomb core disposed in a sleeve-like housing and being operable for dissipating the energy associated with a fall without significant rebound.

### SUMMARY OF THE INVENTION

The present invention is designed to overcome the deficiencies and shortcomings of the devices described above. The present invention is designed to reduce the manufacturing costs and the complexity of assembly. In all exemplary embodiments, an energy absorption device is disclosed for use both with in-line or horizontal life line shock or energy absorbers for fall arrest systems, the energy absorption device being operable for decreasing the deceleration force on a user during a fall and on the end anchor points which are attached to the lifelines. In all exemplary embodiments, the present invention relates to an improved energy or shock absorption device having a biasing element and an adjacent honeycomb core disposed within an elongate housing sleeve, the honeycomb core being operable for dissipating the energy associated with a fall with significant rebound. In exemplary embodiments, the present invention may also be provided with a pretension indicator operable for indicating when an adequate cable pre-tension has been achieved.

According to an exemplary embodiment, the energy absorption device generally includes an elongate housing sleeve constructed from two mating halves, said housing sleeve having disposed therein at least one biasing element, a plurality of reinforcing plates, a fastener for securing the mating halves of the housing sleeve together, and a honeycomb core. In all exemplary embodiments, the honeycomb core is pre-crushed in an axial direction such that the peak load force caused by an initial fall are eliminated and the core is crushed at a substantially uniform level. In exemplary embodiments, a pretension indicator may be provided for assisting a user in obtaining a predetermined tension on the device.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of an energy absorption device constructed in accordance with one exemplary embodiment of the present invention;

FIG. 2 is an exploded, perspective view of the energy absorption device of FIG. 1; and

FIG. 3 is a cross-sectional, perspective view of the energy absorption device of FIG. 1.

### DETAILED DESCRIPTION OF EXEMPLARY EMBODIMENTS

The present invention will now be described more fully hereinafter with reference to the accompanying drawings in which exemplary embodiments of the invention are shown. However, this invention may be embodied in many different forms and should not be construed as limited to the embodiments set forth herein. These exemplary embodiments are provided so that this disclosure will be both thorough and complete, and will fully convey the scope of the invention to those skilled in the art. Like reference numbers refer to like elements throughout the various drawings. Further, as used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The present invention overcomes the shortcomings of conventional energy absorption devices by providing an absorption device which includes a honeycomb core which is operable for dissipating the energy of a fall without significant rebound. Further, the present invention overcomes the shortcomings of conventional devices by eliminating high initial force spikes or peak leads caused by friction or initial collapsing resistance. This advantageously allows for a higher average force, which decreases the distance to arrest the fall, reducing the risk of hitting a hazard below the falling user.

In all exemplary embodiments of the present invention, an energy absorption device is provided which decreases the deceleration force on a user during a fall and on end anchor points that attach a horizontal or in-line life line to a structure. It will be understood by those skilled in the art that the energy absorption device of the present invention may be used with safety harnesses, lanyards, fall-limiters and the like to provide energy absorption in the event of as fall. In all exemplary embodiments, the energy absorption device generally includes an elongate housing sleeve constructed from two mating halves, said housing sleeve having disposed therein at least one biasing element, a plurality of reinforcing plates, a fastener for securing the mating halves of the housing sleeve together, and a honeycomb core. In all exemplary embodiments, the honeycomb core is pre-crushed in an axial direction such that the peak load force caused by an initial fall are eliminated and the core is crushed at a substantially uniform level. In exemplary embodiments, a pretension indicator may be provided for assisting a user in obtaining a predetermined tension on the device.

In all exemplary embodiments, energy absorption is achieved by the provision of a honeycomb core of crush resistant material which is designed to compress or collapse under a load force after a biasing element has first been substantially, fully compressed to a solid like state. The compression or collapsing of the honeycomb core serves to cause the energy of a fall to dissipate without significant rebound. As is understood by those skilled in the art, rebound is undesirable since may cause additional forces and motion, which, in turn, may undesirably increase the exposure of the user to injury.

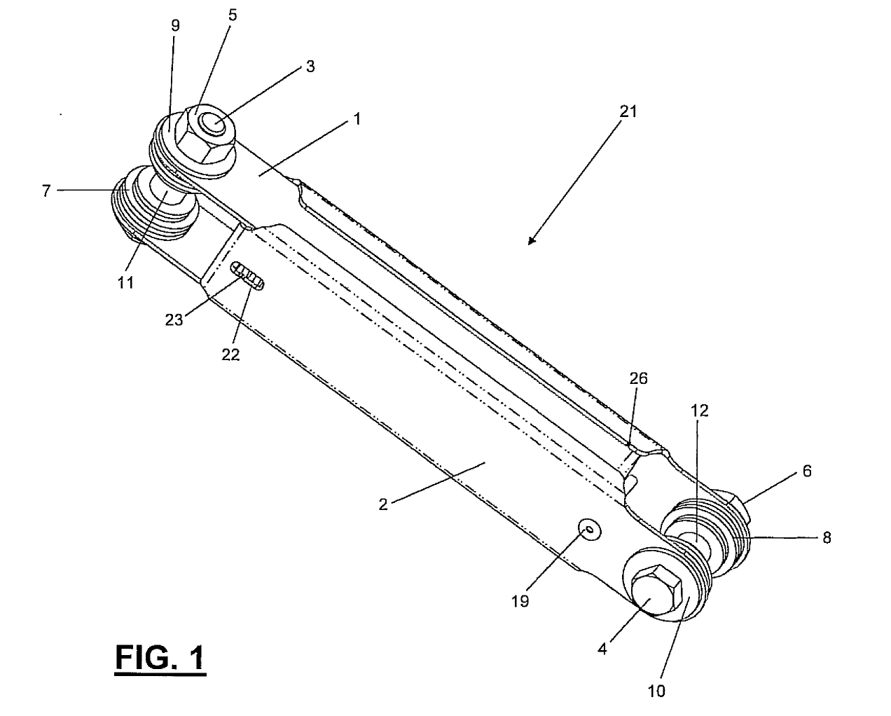

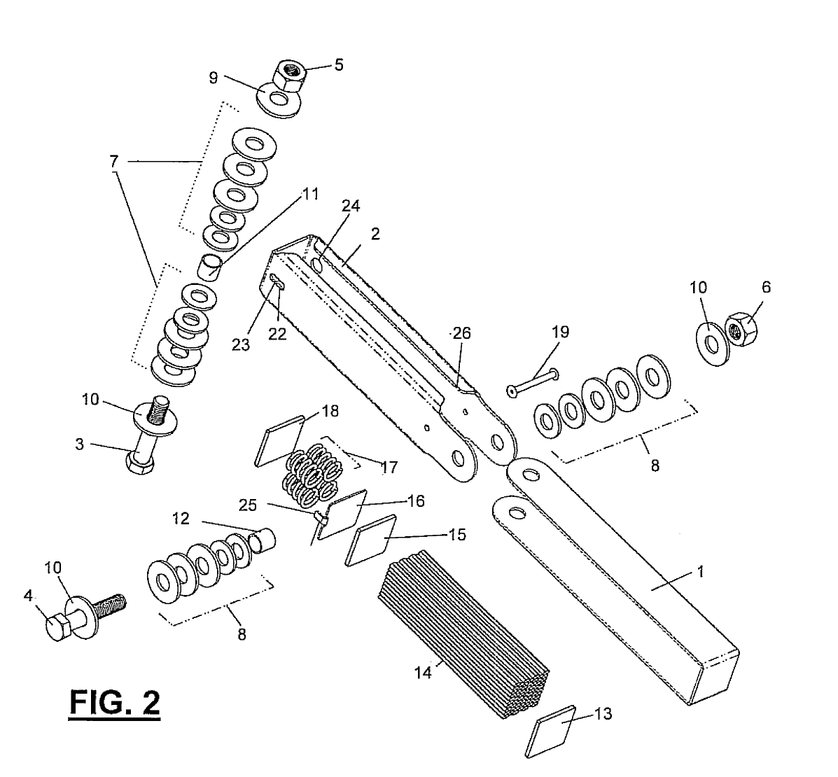

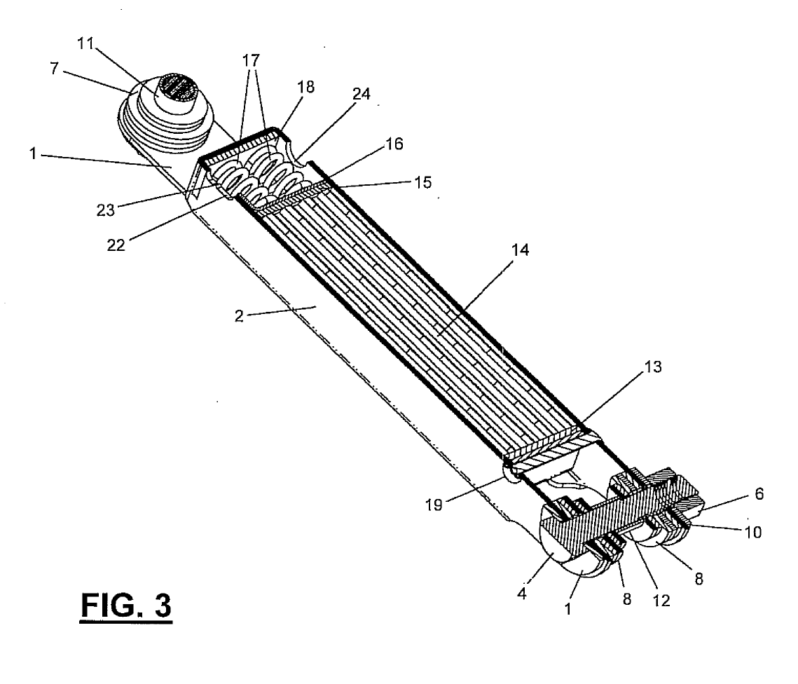

Referring now specifically to the drawings, an energy absorption device constructed in accordance with an exemplary embodiment of the present invention is illustrated in FIGS. 1-3, and shown generally at reference numeral 21. The energy absorption device 21 may be adapted for use with safety harnesses, lifelines, and other fall protection devices (not shown) worn by a worker to arrest the worker in the event of a fall. In exemplary embodiments, the energy absorption device 21 is an elongate housing sleeve. The housing sleeve 21 is comprised of a first half 1 and a second half 2, said halves 1 and 2 being operable for slidably engaging each other thereby forming a cavity within the sleeve 21. In exemplary embodiments, the halves 1 and 2 are designed to have an elongate generally U-shaped frame structure, thereby forming a sleeve 21 with a generally square shaped cross-section. However, it will be understood by those skilled in the art that the sleeve 21 may have any type of cross-sectional geometry including, but not limited to, a cylindrical cross-section as long as the halves maintain their sliding engagement.

In exemplary embodiments, each half 1 and 2 is provided with a generally rounded nose portion at its respective distal end. Apertures are provided in the nose portions of the halves 1 and 2 for receiving bolts or pins 3 and 4 which are operable for attachment to a cable or stationary object. As illustrated, the bolts 3 and 4 generally include a plurality of nuts Sand 6, inner washers 7 and 8, outer washers 9 and 10, and spacers 11 and 12. However, it will be understood by those skilled in the art that any type of bolt or pin may be utilized without departing from the scope of this invention. Once secured to the respective halves 1 and 2, a cable or carabineer may thereafter be attached to the bolts 3 and 4 about the spacers 11 and 12 such that pre-tension forces may be applied to the device 21 during installation of the life line.

As shown, the second half 2 is provided with inward facing flanges 26 operable for receiving and maintaining the first half 1 in position. A fastener 19 is provided along the frame of the second half 2 for securing the halves 1 and 2 together and preventing expansion of the sleeve 21 in a direction which would disengage the halves 1 and 2. The fastener 19 also serves to prevent the sleeve 21 from collapsing in the axial direction and to maintain adequate spacing between the bolts 3 and 4. Still further, the fastener 19 serves as a tamper resisting mechanism. Once the halves 1 and 2 are slidably engaged with one another, the fastener 19 is secured in place and abuts the outer most surface of the first half 1. In exemplary embodiments, a wall of the second half 2 is provided with a window 22 and a tension pointer 23 for allowing a user to inspect the device 21 and determined if an acceptable pre-tension level has been achieved in the energy absorption device installation.

In exemplary embodiments, disposed within the sleeve 21 is a biasing element 17, a honeycomb core 14, and reinforcing plates 13, 15, 16 and 18. In exemplary embodiments, the biasing element 17 is at least one spring. The reinforcing plates 13, 15, 16 and 18 are provided to augment the components in which they are adjacent to. Attached to at least one of the reinforcing plates, 16, is a tension indicator 20 which works in conjunction with the tension pointer 23 located in the window 22 of the second half 2. In exemplary embodiments, the tension indicator 20 includes a calibration feature (not shown). As compressive load forces are applied to the biasing element 17, reinforcing plate 16 moves and the tension indicator 20 comes into a user's sight through the window 22 and indicates the amount of tension being applied to the device 21. Further, opposite the window 22 of the second half 2 is a second window 24 for allowing a user to inspect the biasing element 17.

In exemplary embodiments, the honeycomb core 14 is generally comprised of a symmetric cellular web of thin walled hollow members fused together. In exemplary embodiments, the hollow thin walled members of the honeycomb core 14 may have any number of sides and form a hexagonal, square, triangular, rectangular or tubular geometric cross-section. In exemplary embodiments, the honeycomb core 14 is constructed of aluminum. However, it will be appreciated by those skilled in the art that any suitable material may be used, including, metal, steel, paper, cardboard, plastic, or fiberglass. Further, the orientation of the thin walled hollow members may be unidirectional or mixed.

The use of the honeycomb core 14 is particularly advantageous because the honeycomb core 14 absorbs energy by crushing or collapsing under load forces. Thus, in the event of a fall, the biasing element 17 will compress and thereafter the honeycomb core 14 will compress. After honeycomb core 14 has exceeded its ultimate compressive strength, it will continue to deform plastically and crush uniformly. The honeycomb core 14 is designed such that it will crush at virtually a constant stress level (dependent on the core material and density), hence its absorption capacity is predictable, making it ideal for energy absorption applications. As previously mentioned, in exemplary embodiments, the honeycomb core 14 is often pre-crushed in an axial direction slightly to remove the compressive peak load.

The energy absorption device is generally operated by first attaching the device 21 at each end to a cable or stationary object. The cable may be pre-tensioned to a predetermined level through the use of a turn-buckle or come-along. As the absorption device 21 is pre-tensioned, the biasing element 17 compresses to a predetermined state. Thereafter, compressive forces are placed upon the honeycomb core 14. In the event of a fall, addition tensile forces are placed upon the energy absorption device 21 such that the forces pull the respective halves 1 and 2 of the housing sleeve 21 such that the biasing element 17 compresses further. Once the biasing element 17 reaches a substantially fully compressed state the honeycomb core 14 begins to compress or crush under the load. As the honeycomb core 14 crushes it dissipates or absorbs the energy of the fall and assists in arresting the fall without any significant rebound. Advantageously, as the biasing element 17 and the honeycomb core 14 compress the housing sleeve 21 expands in length in the direction of the compressive force. This expansion also assists in the arresting of the fall without significant rebound.

The embodiments described above provide advantages over conventional energy absorption devices and associated methods of manufacture. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Furthermore, the foregoing description of the preferred embodiment of the invention and best mode for practicing the invention are provided for the purpose of illustration only and not for the purpose of limitation—the invention being defined by the claims.

What is claimed:

1. An energy absorption device for absorbing energy transferred by a tension load, the energy absorption device comprising:
a generally hollow housing sleeve, said housing sleeve being comprised of mating halves and being operable for expanding and contracting;
at least one biasing element disposed within the housing sleeve; and
a honeycomb core disposed within the housing sleeve and adjacent the biasing element,
wherein the biasing element and the honeycomb core compress under an excess tension load such energy is dissipated without significant rebound.

2. The energy absorption device of claim 1, further comprising a plurality of reinforcing plates, said plates being positioned intermediate and about the biasing element and the honeycomb core.

3. The energy absorption device of claim 1, further comprising a fastener for securing the mating halves of the housing sleeve together.

4. The energy absorption device of claim 1, wherein the mating halves of the housing sleeve are slidably engaged with each other.

5. The energy absorption device of claim 1, wherein the honeycomb core is pre-crushed in an axial direction such that the peak load forces caused by an initial fall are eliminated and the core is crushed at a substantially uniform level.

6. The energy absorption device of claim 1, further comprising a pretension indicator for assisting a user in verifying that a preload tension is acceptable.

7. The energy absorption device of claim 1, wherein the biasing element is a spring.

8. The energy absorption device of claim 1, wherein the honeycomb core is comprised of a symmetric cellular web of thin walled hollow members fused together.

9. The energy absorption device of claim 1, wherein the thin walled hollow members may have any number of sides and form a hexagonal, square, triangular, rectangular or tubular geometric cross-section.

10. The energy absorption device of claim 1, wherein the orientation of the thin walled hollow members may be unidirectional or mixed.

11. The energy absorption device of claim 1, wherein as the biasing element and the honeycomb core compress as the housing sleeve expands in length in the direction of the compressive force.

12. An energy absorption device for absorbing energy transferred by a tension load, the energy absorption device comprising:
a generally hollow housing sleeve, said housing sleeve being comprised of mating halves and being operable for expanding and contracting;
at least one biasing element disposed within the housing sleeve; and
wherein the biasing element compresses under the excess tension load such that energy is dissipated.

13. The energy absorption device of claim 12, further comprising a honeycomb core disposed within the housing sleeve and adjacent the biasing element, wherein the honeycomb core compresses after the biasing element has substantially fully compressed under the excess tension load such that energy is absorbed by the honeycomb core.

14. The energy absorption device of claim 13, further comprising a plurality of reinforcing plates, said plates being positioned intermediate and about the biasing element and the honeycomb core.

15. The energy absorption device of claim 12, further comprising a fastener for securing the mating halves of the housing sleeve together.

16. The energy absorption device of claim 12, wherein the mating halves of the housing sleeve are slidably engaged with each other.

17. An energy absorption device for absorbing energy transferred by a tension load, the energy absorption device comprising:
a generally hollow housing sleeve, said housing sleeve being comprised of mating halves and being operable for expanding and contracting;
a honeycomb core disposed within the housing sleeve; and
wherein the honeycomb core compresses under the excess tension load such that energy is dissipated without significant rebound.

18. The energy absorption device of claim 17, further comprising a biasing element adjacent to the honeycomb core.

19. The energy absorption device of claim 18, further comprising a plurality of reinforcing plates, said plates being positioned intermediate and about the biasing element and the honeycomb core.

20. The energy absorption device of claim 17, further comprising a fastener for securing the mating halves of the housing sleeve together.
